(19) United States
(12) Patent Application Publication
(10) Pub. No.: US 2007/0119168 A1
(43) Pub. Date: May 31, 2007

(54) Turbocharged internal combustion engine

(76) Inventor: James William Griffith Turner, Norfolk (GB)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 10/586,068

(22) PCT Filed: Jan. 14, 2005
(86) PCT No.: PCT/GB05/00120

§ 371 Date: Jul. 14, 2006

(30) Foreign Application Priority Data
Jan. 14, 2004 (GB) 0400808.2
Jan. 14, 2004 (GB) 0400794.4

(51) Int. Cl. F02D 23/00; F02B 33/44

(52) U.S. Cl. 60/600; 60/602; 60/612

(57) ABSTRACT

A turbocharged internal combustion engine comprising: a turbocharger (15) actuators for opening and closing the exhaust valves (a, b) and an electronic controller which controls operation of the actuators to thereby control opening and closing of the exhaust valves (a, b). The exhaust valves comprise a first exhaust valve (a) connected to a first exhaust duct (14) and a second exhaust valve (16) connected to a second exhaust duct (16). The first exhaust duct (14) is connected to the turbocharger (15) so that exhaust gases passing through the first exhaust duct (14) drive the turbocharger (15). The second exhaust duct (16) bypasses the turbocharger (15) and the combusted gases flowing through the second exhaust duci are exhausted without passing through the turbocharger (15). The electronic controller by controlling the opening and closing of the first (a) and second (b) exhaust valves controls what proportion of the combusted gases leaving the combustion chamber flow through each of the first (14) and second (16) exhaust ducts.

The present invention relates to a turbocharged internal combustion engine.

Turbocharged internal combustion engines are well known. However, it has always been a problem to control effectively the speed of rotation of turbochargers in engines in order to control the boost applied to the intake air. Wastegates have been necessary or complicated valving arrangements. Furthermore, now that it is necessary to meet strict emissions regulations for all engines, the use of high pressure turbochargers is problematic because the restrictions on flow imposed by such turbochargers and the cooling of exhaust gases thereby tends to lead to unacceptable delays in catalytic converter light off. Traditionally, in engines with two-stage turbocharging it has been a problem to control elegantly the boost provided by each turbocharger in relation to the other.

The present invention provides a turbocharged internal combustion engine comprising:

a variable volume combustion chamber;

inlet valves means controlling flow of air into the combustion chamber;

fuel delivery means for delivering fuel into the air to be mixed therewith;

exhaust valve means for controlling flow of the combusted gases from the combustion chamber;

compressor means for compressing the air prior to admission of the air into the combustion chamber;

actuator means opening and closing the exhaust valve means; and

an electronic controller which controls operation of the actuator means to thereby control opening and closing of the exhaust valve means; wherein:

the exhaust valve means comprises at least a first exhaust valve connected to a first exhaust duct and at least a second exhaust valve connected to a second exhaust duct, separate and independent from the first exhaust duct;

the compressor means comprises a first turbocharger and the first exhaust duct is connected to the first turbocharger so that exhaust gases passing through the first exhaust duct drive the first turbocharger to rotate;

the second exhaust duct bypasses the first turbocharger and the combusted gases flowing through the second exhaust duct are exhausted without passing through the first turbocharger; and

the electronic controller by controlling operation of the actuating means and thereby the opening and closing of the first and second exhaust valves is operable to control what proportion of the combusted gases leaving the combustion chamber flow through each of the first and second exhaust ducts.

By the use of actuators controlled by an electronic controller the operation of the exhaust valves can be controlled in such a way that the controller can control the volume and rate of flow of combusted gases through the first turbocharger and thereby control operation of the first turbocharger in an elegant way.

Preferred embodiments of the present invention will now be described with reference to the accompanying drawings, in which:

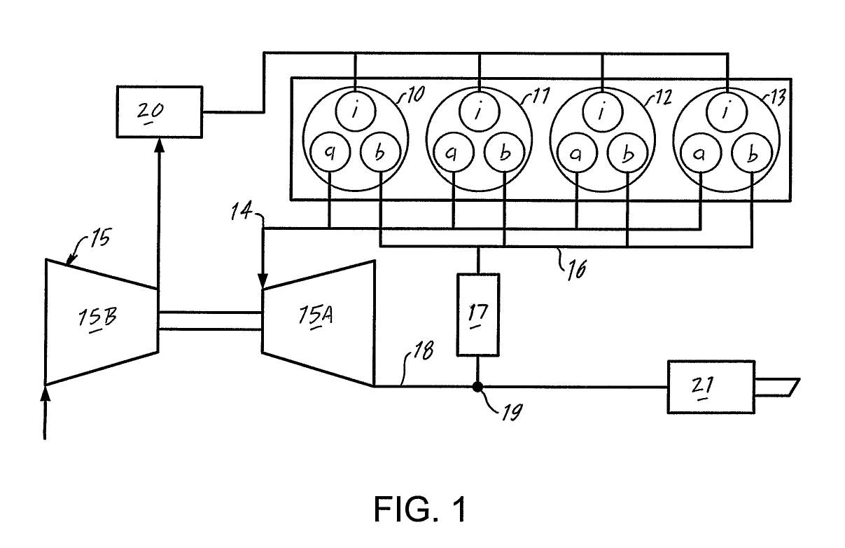

FIG. 1 shows schematically a first embodiment of an internal combustion engine according to the present invention, the engine having a single stage charging system; and

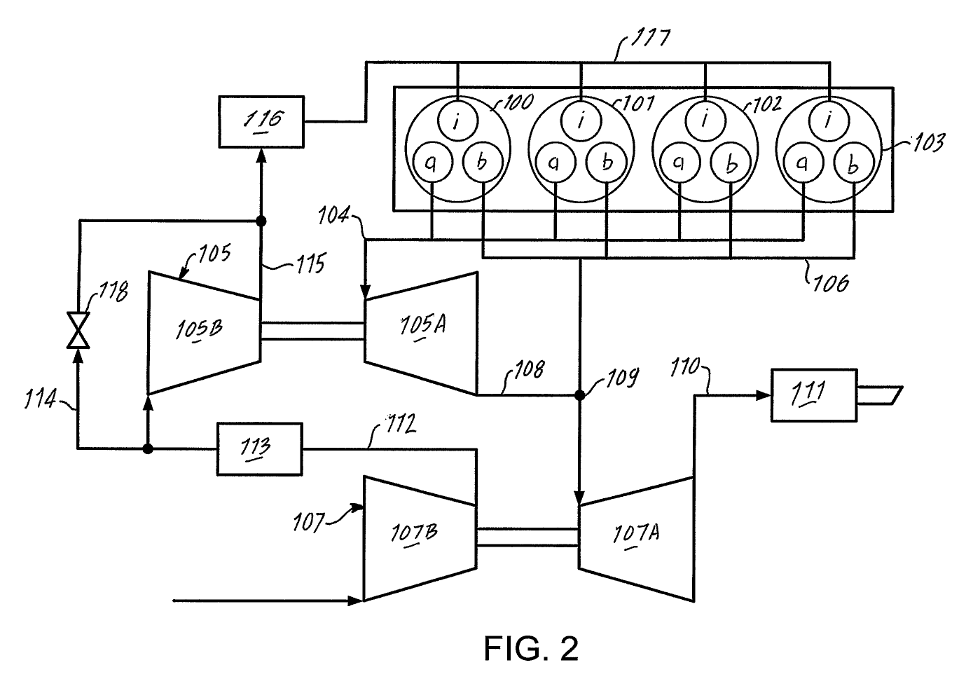

FIG. 2 shows a second embodiment of a turbocharged internal combustion engine according to the present invention, the engine having a two-stage charging system;

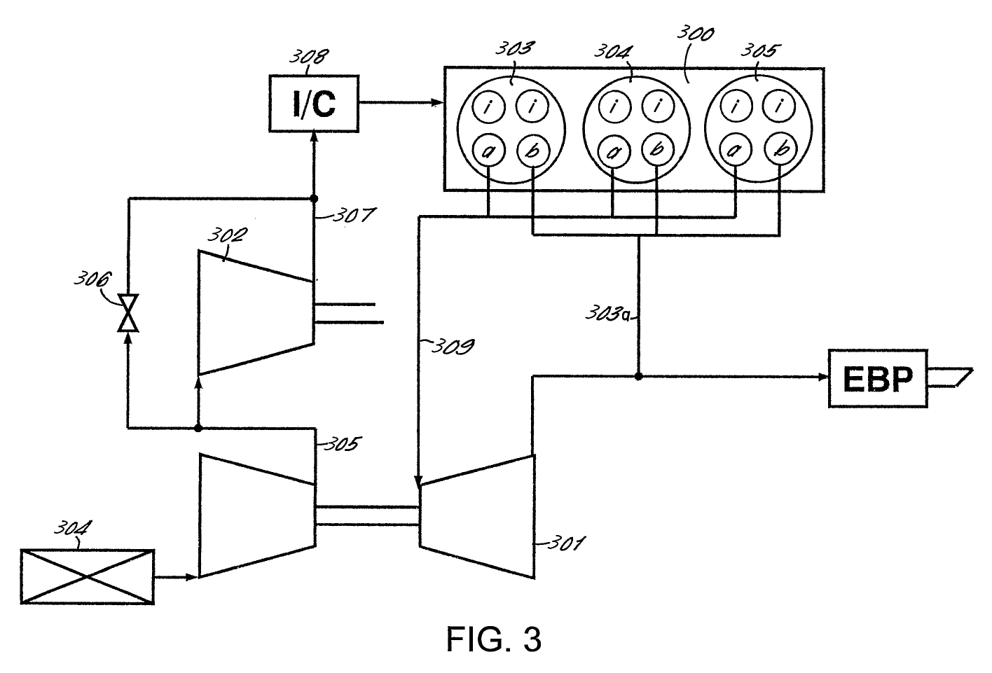

FIG. 3 shows a third embodiment of a turbocharged internal combustion engine according to the present invention, the engine having a turbocharger and a supercharger;

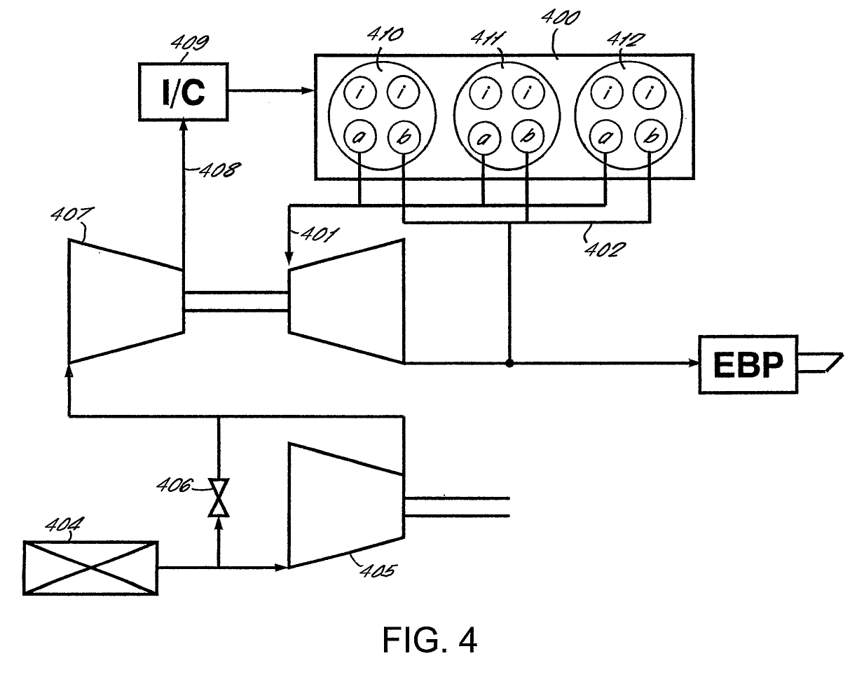

FIG. 4 shows a fourth embodiment of a turbocharged internal combustion engine according to the present invention, the engine having an electrically powered compressor and a turbocharger;

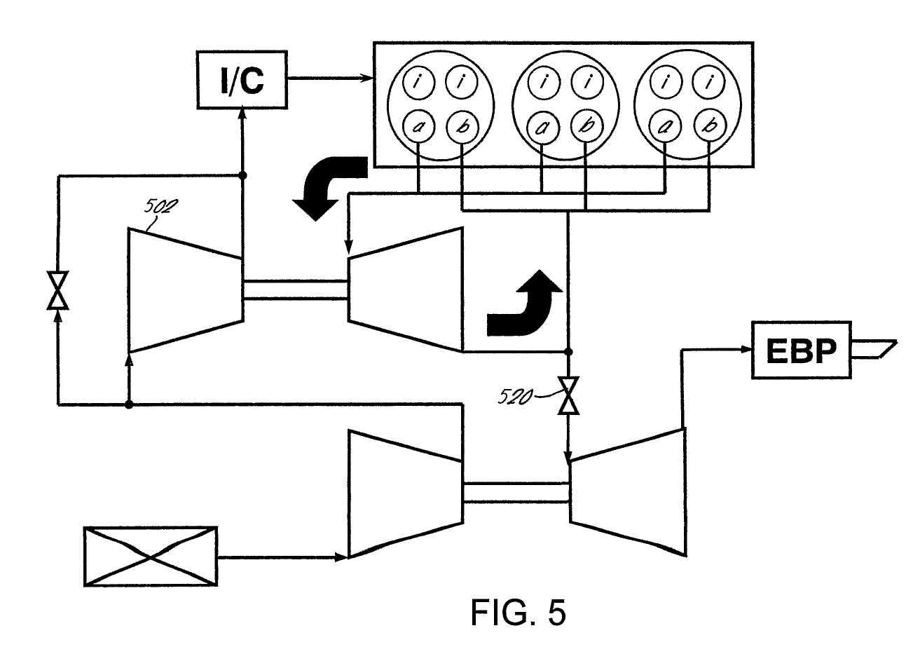

FIG. 5 shows a fifth embodiment of a turbocharged engine according to the present invention, the engine having a starting valve allowing modified operation on starting; and

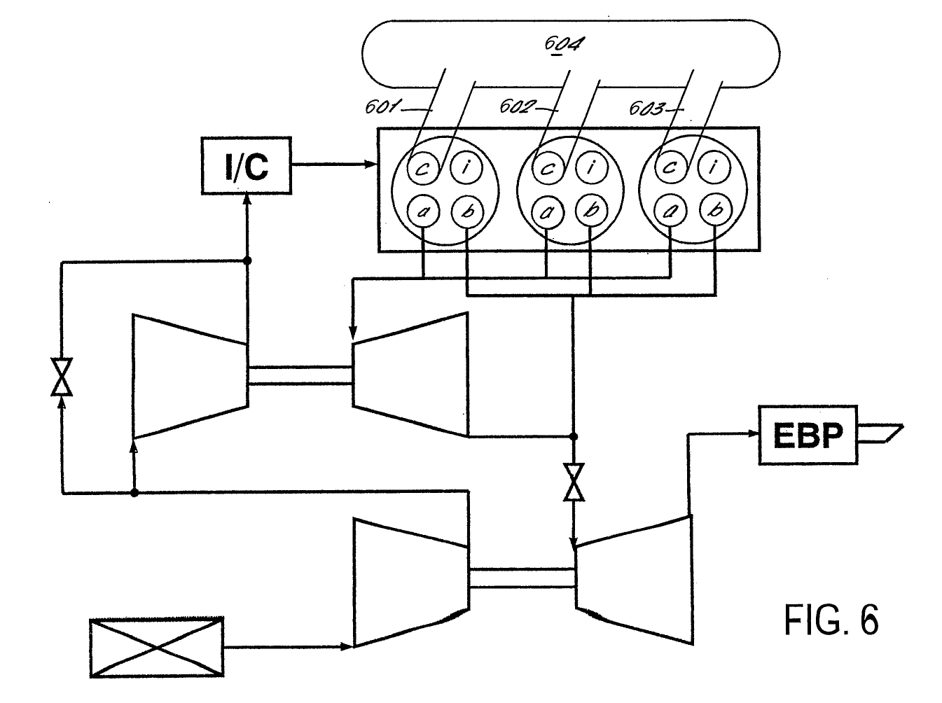

FIG. 6 shows a sixth embodiment of a turbocharged internal combustion engine according to the present invention, the engine having a storage tank for compressed gases.

In FIG. 1 there can be seen a four-cylinder engine having four cylinders 10, 11, 12 and 13. Each cylinder has an inlet valve “i” and two exhaust valves “a” and “b”. The exhaust valves “a” and “b” at least are each operated by a hydraulic actuator connected to the valve. Each hydraulic actuator will be controlled by an electronic controller (not shown) which will typically be part of the engine management of the system. Each exhaust valve “a” will be opened and closed independently of the exhaust valve “b” in the same cylinder.

Combusted gases flowing from the cylinders 10, 11, 12 and 13 flow through the exhaust valves “a” to a first exhaust duct 14. This exhaust duct 14 relays the combusted gases to the turbine stage 15a of a turbocharger 15.

The exhaust valves “b” are all connected to a second exhaust duct 16 through which combusted gases can flow from the cylinders 10, 11, 12 and 13 through the exhaust valves “b” to a starter catalytic converter 17.

The combusted gases expanded in the turbine 15a are output from the turbocharger 15 via an exhaust duct 18, which is joined to the exhaust duct 16 at a joint 19. At the joint 19 the combusted gases flowing from the turbocharger 15 combine with the combusted gases flowing through the exhaust duct 16 and then the combined flow passes through a second catalytic converter 21 and then to atmosphere.

Fresh charge air is drawn into the compressor section 15b of the turbocharger 15 and is then relayed via an intake passage 19 to the intake valves “i” of the cylinders 10, 11, 12 and 13, the charge air passing through an intercooler on its way to the cylinders.

The electronic controller can use its control of the actuators to control the opening and closing of the exhaust valves “a” and “b” to control what proportion of the total combusted gases flowing from each cylinder flow to the exhaust duct 14 and what proportion of the combusted gases flow through the exhaust duct 16. In this way the controller can control operation of the turbocharger 15. When greater boost is required then a greater proportion of the total combusted gases expelled from the cylinders 10, 11 12 and 13 is fed through the turbocharger 15 and vice versa. On start-up of the engine the majority of the combusted gases expelled from the cylinders 10, 11, 12 and 13 (if not the totality of the combusted gases expelled) will pass through the exhaust duct 16 in order to ensure an early light off of the starter catalytic converter 17 and therefore reduce the emissions on engine start-up.

In FIG. 2 a second variant of engine according to the present invention is shown. This engine has four cylinders 100, 101, 102 and 103, each cylinder having an intake valve “i”, an exhaust valve “a” and an exhaust valve “b”. The exhaust valves “a” and “b” at least are operated by hydraulic actuators under the control of an electronic controller (not shown). Each exhaust valve “a” can be operated independently from the exhaust valve “b” in the same cylinder.

The exhaust valves “a” of the cylinders 100, 101, 102 and 103 are all connected to a first exhaust duct 104 which leads the combusted gases to the turbine part 105a of a high pressure turbocharger 105. The exhaust valves “b” of the cylinders 100, 101, 102 and 103 are all connected to an exhaust duct 106 through which the combusted gases flow to a turbine section 107a of a low pressure turbocharger 107, bypassing the high pressure turbocharger 105.

Expanded combusted gases exiting the turbine part 105a of the turbocharger 105 flow via an exhaust duct 108 to a joint 109 where the expanded combusted gases are fed into the flow of combusted gases passing along the exhaust duct 106. It is the combined flow of the combusted gases passing directly from the exhaust valves “b” and the combusted gases exiting the turbocharger 105 which are then fed to the turbine 107a of the low pressure turbocharger 107.

The combusted gases exiting the turbine 107a of the turbocharger 107 pass through an exhaust passage 110 to atmosphere via a catalytic converter 111.

Charge air drawn into the compressor part 107b of the turbocharger 107 is expelled through an intake duct 112 to be passed through an intercooler 113. The compressed air, once cooled in the intercooler 113 can then pass either through the compressor part 105b of the high pressure turbocharger 105 or can pass along a bypass passage 114, bypassing the turbocharger 105 completely.

The compressed air supplied to the turbocharger 105 will be supplied at a first pressure and will then be pressurised to a higher second pressure by the turbocharger 105. The pressurised air leaving the compressor 105b passes through a duct 115 to be recombined with air flowing through the bypass passage 114. The combined air flow then passes through an intercooler 116 and an intake duct 117 to the intake valves “i”.

A bypass valve 118 is provided in the bypass passage 114. The bypass valve 118 is controlled by the electronic controller. Operation of the bypass valve 118 will enable the electronic controller to control how much of the intake air passes through the high pressure turbocharger 105.

The electronic controller controls opening and closing of the exhaust valves “a” and “b” (through which control of the actuators connected to the exhaust valves) in order to control what proportion of the total flow of combusted gases from the cylinders 100, 101, 102 and 103 flow through the exhaust duct 104 and what proportion of the combusted gases flow through the exhaust duct 106. In this way, the electronic controller can control operation of the turbochargers 105 and 107.

In certain circumstances it will be preferable that all or at least the majority of the flow of combusted gases bypasses the turbocharger 105 completely. In this circumstance, the exhaust valves “a” are kept totally (or mostly) closed and the exhaust valves “b” are opened and closed on their own in each cycle. In this circumstance the electronic controller will also open fully the bypass valve 118 so that charge air does not pass through the turbocharger 105. For instance it is desirable on start-up of the engine to bypass the turbocharger 105 completely. Since the turbocharger 105 is a high pressure turbocharger, it will provide a large restriction on the flow of combusted gases from the cylinders. This restriction and the resultant cooling of the combusted gases will increase the time to light off of the catalyst 111. On the other hand, the low pressure turbocharger 107 will place far less a restriction on the combusted gases and therefore it is preferable that at start up conditions the combusted gases flow only through the turbocharger 107.

The system described in FIG. 2 removes the need for a waste gate which is, by its very nature, wasteful. In the FIG. 2 arrangement all the combusted gases pass through the turbine 107.

The level of boost provided to the intake air supplied to the intake valves “i” can easily be controlled by electronic controller by varying the valve timing of the exhaust valves “a” and “b” in order to control the gas flow through the exhaust duct 104. Also, the controller can control boost by controlling the bypass valve 118.

The low pressure turbocharger 107 will be a turbocharger with a large turbine, giving a resistance to the flow of combusted gases much less than the high pressure turbocharger 105, which has a smaller turbine. However, the larger turbine size of the low pressure turbocharger 107 can lead to throttle response problems which are particularly problematic in the use of the engine in an automobile. This problem is ameliorated by the present invention by the electronic controller recognising times of acceleration of the engine and in such times diverting the majority of the flow of combusted gases to the high pressure turbocharger 105 which will react quickly when the throttle of the engine is open. Obviously, the bypass valve 118 is closed in such circumstances, in order that the intake air received by the inlet valves “i” is boosted to its maximum.

At high engine speeds the high pressure turbocharger 105 could provide an excess of boost if not suitably controlled by the electronic controller controlling the flow of combusted gases through the exhaust duct 104 and the flow of intake air through the bypass passage 114. Typically at full loads and high engine speeds in steady state conditions the high pressure turbocharger 105 will be in the main bypassed so that the majority of intake air will flow in the bypass passage 114 and the majority of combusted gas flow will be through the exhaust duct 106.

FIG. 3 shows schematically a three cylinder compression ignition internal combustion engine 300 according to the present invention, with a forced induction system comprising a low pressure stage having a turbo-charger 301 and a high pressure stage having a super-charger 302. In the figure three cylinders 303, 304 and 305 are shown, each of which has an exhaust valve “a” which controls flow of exhaust gas via a passage 309 to a turbine of the low pressure turbocharger 301. Each cylinder also has an exhaust valve “b” which controls flow of exhaust gas to a bypass passage 303. The bypass passage 303 allows exhaust gas to flow straight to atmosphere bypassing the low pressure turbocharger 301.

The FIG. 3 engine works with charge air being drawn in via an air filter 304 into the compressor part of the low pressure turbocharger 301. The pressurised air then flows out via a passage 305 to a bypass valve 306 or to the compressor part of a high pressure supercharger 302. Then the charge air pressurised in the high pressure supercharger 302 flows out through the passage 307. The bypass valve 306 could be controlled by the engine management system to control the amount of pressurised charge air flowing into the compressor of the supercharger 302. Alternatively, it could be a simple mechanical pre-loaded valve which would open at a defined pressure to limit the pressure of the scavenge air flowing as an input to the compressor of the supercharger 302. The bypass scavenge air and the pressurised air exiting the supercharger 302 are mixed before they flow through an intercooler 308 and then on to the cylinders 303, 304, 305 to be delivered via inlet valves “i”.

The engine management system controls the opening of the exhaust valves “a” and “b” in each cylinder to control the amount of pressurised exhaust gas flowing to the turbine of the low pressure turbo charger 301. A portion of the exhaust gas is allowed to flow to the turbine of the turbo charger 301 and a portion is allowed to flow via the bypass passage 303 directly to atmosphere.

It is envisaged that the supercharger 302 would typically be a Roots blower type supercharger. It could be a clutched supercharger so that it is operated only in certain engine operating conditions, under control of the electronic controller.

A fourth variant of engine is shown in FIG. 4. An engine 400 is shown with three cylinders each of the type shown in FIG. 1. Again, each cylinder has four cylinder head valves. Each cylinder has an exhaust valve “a” connected to a first exhaust duct 401 and each cylinder has an exhaust valve “b” connected to a second exhaust duct 402 separate from the first exhaust duct 401.

In the FIG. 4 engine fresh air is drawn in via a filter 404 to be compressed by an electrically powered compressor 405. The electrically powered compressor 405 is controlled by an electronic controller to operate at low speeds of the engine and/or during starting, but does not operate otherwise. In other conditions a bypass valve 406 is opened to allow charge air to bypass the low pressure electrically driven compressor 405.

Air exiting the low pressure compressor 405 or passing through the bypass valve 406 then flows on to a high pressure turbocharger 407 to be compressed in the turbocharger and then output via a duct 408 to an intercooler 409 and then on to the cylinders of the engine via inlet valves “i”.

Combusted gases can be exhausted from the cylinders 410, 411, 412 either via the exhaust valves “a” or by the exhaust valves “b”. These valves are controlled by actuators controlled by an engine management system. The engine management system will control operation of the valves “a” and “b” to control what proportion of the exhaust gases flow through the exhaust duct 401 and what proportion flow through the exhaust duct 402. The exhaust gases flowing through the exhaust duct 401 flow to the turbine of the high pressure turbo charger 407, whilst the exhaust gases flowing through the exhaust duct 402 bypass the turbocharger 407 and flow directly to atmosphere.

FIG. 5 shows a variation on the turbo-charging system of the engine of FIG. 2, the turbo-charging system beneficially modified to assist starting of the engine (apart from during starting, the engine will operate as described above). The additional feature of the engine is the starting valve 520. This will be controlled by the engine management system. During engine starting the starting valve 520 will be closed. Also the controller will vary the operation of the exhaust valves. By closing the valve 520 and varying operation of the exhaust valves the controller can arrange the engine to operate such that gas is compressed in each of the combustion chambers and then expelled via the exhaust valves “a”. The expelled gas powers the high pressure turbocharger 502 and starts it spinning. The gas exhausted from the turbine of the turbocharger 502 is then fed back into the combustion chambers via the exhaust valves “b”. The gas that is fed back in is then pressurised again, let out by the exhaust valves “a” and the cycle is repeated. This enables the engine to work as a pneumatic pump to start the high pressure turbo charger 502 spinning rapidly prior to injection of fuel into the combustion chambers and starting of the engine. This is very beneficial, particularly since the recirculated air will be hotter than fresh charge air. Providing this facility removes the need for a supercharger or an electrically driven compressor, which would be typically chosen to assist starting of a compression ignition engine not having the fast start mode of operation illustrated in FIG. 5.

Whilst the FIG. 5 arrangement for fast start operation systems is shown applied to the engine illustrated in FIG. 2 it is possible that the engines of other figures could be arranged to provide fast start modes with the gases leaving the turbo chargers recycled via the exhaust valves “b” into the combustion chambers for further compression.

FIG. 6 shows a further example of an engine according to the present invention. In this variant each cylinder has an additional type of exhaust valve “c”. The exhaust valves “a” and “b” will be operated as described before, save during engine braking and engine starting when the valve “c” may be used. The additional exhaust valves “c” are connected via passages 601, 602, 603 to a storage tank 604 for storing compressed gases. The valves “c” are controlled during engine braking to allow compressed gases to flow from the cylinder to the storage tank 604. The valves “c” can then be opened when needed (e.g. on starting of the engine) to supply previously stored compressed gases to the cylinder, e.g. to expand in the cylinder and drive the pistons to reciprocate.

The valves “c” are operated to allow flow of compressed gas to the storage tank 604 only when the tank is not already pressurised to its limit. The valves “c” allow flow of gas from the storage tank 604 to the cylinders only when the pressure in the storage tank 604 is sufficient.

In the embodiments shown in FIGS. 2 and 5 it is possible that the lower pressure turbo charger could be replaced with an electrically-assisted turbocharger, which is assisted by electrical power at low engine speeds or on starting, but is otherwise powered by the exhaust gases from the engine. An electrically-assisted turbocharger could be used to output electrical power at high engine speeds.

The engines described above could be operated either with spark ignition or with compression ignition. The invention is applicable to reciprocating piston engines with any number of cylinders and furthermore is applicable to internal combustion engines other than reciprocating piston engines (e.g. rotary engines).

The exhaust valves “a” and “b” described above will be poppet valves operated by hydraulic actuators. However, the poppet valves could be operated by any other suitable form of actuator, e.g. electromagnetic actuators. Indeed the poppet valves could be replaced by sleeve valves or any other suitable valving arrangement controllable by actuator.

The inlet valves “i” described above would preferably themselves be controlled by actuators under the control of the electronic controller but this is not necessary and any form of operation of the valves could be used, e.g. conventional cam and tappet operation.

The turbochargers described above could be fixed geometry or variable geometry turbochargers.

1. A turbocharged internal combustion engine comprising:
a variable volume combustion chamber;
inlet valve means controlling flow of air into the combustion chamber;
fuel delivery means for delivering fuel into the air to be mixed therewith:
exhaust valve means for controlling flow of combusted gases from the combustion chamber;
compressor means for compressing the air prior to admission of the air into the combustion chamber;
actuator means for opening and closing the exhaust valve means; and
an electronic controller which controls operation of the actuator means to thereby control opening and closing of the exhaust valve means, wherein:
the exhaust valve means comprises at least a first exhaust valve connected to a first exhaust duct and at least a second exhaust valve connected to a second exhaust duct separate and independent from the first exhaust duct;
the compressor means comprises a first turbocharger and the first exhaust duct is connected to the first turbocharger so that exhaust gases passing through the first exhaust duct drive the first turbocharger to rotate;
the second exhaust duct bypasses the first turbocharger and the combusted gases flowing through the second exhaust duct are exhausted without passing through the first turbocharger; and
the electronic controller by controlling operation of the actuator means and thereby the opening and closing of the first and second exhaust valves is operable to control what proportion of the combusted gases leaving the combustion chamber flow through each of the first and second exhaust ducts;
the compressor means comprises additionally a second turbocharger;
the first turbocharger is a high pressure turbocharger which can receive compressed air at a first pressure from the second turbocharger, which is a low pressure turbocharger, and the first turbocharger compresses the air to a second higher pressure; and
combusted gases leaving the first turbocharger after expansion in a turbine thereof are combined with the combusted gases flowing in the second exhaust duct and then the combined flow of combusted gases drive the second turbocharger to rotate.

2. A turbocharged internal combustion engine as claimed in claim 1 wherein combusted gases leaving the second turbocharger flow through a catalytic converter and then to atmosphere.

3. A turbocharged internal combustion engine as claimed in claim 1 comprising additionally a first intercooler through which air compressed in the second low pressure turbocharger passes before reaching the first high pressure turbocharger.

4. A turbocharged internal combustion engine as claimed in claim 1 comprising additionally an intake air bypass passage through which air compressed by the second turbocharger can flow to the intake valve means bypassing the first turbocharger and bypass valve means controlling flow of the compressed air through the bypass passage.

5. A turbocharged internal combustion engine comprising:
a variable volume combustion chamber;
inlet valve means controlling flow of air into the combustion chamber;
fuel delivery means for delivering fuel into the air to be mixed therewith;
exhaust valve means for controlling flow of combusted gases from the combustion chamber;
compressor means for compressing the air prior to admission of the air into the combustion chamber;
actuator means for opening and closing the exhaust valve means; and
an electronic controller which controls operation of the actuator means to thereby control opening and closing of the exhaust valve means, wherein:
the exhaust valve means comprises at least a first exhaust valve connected to a first exhaust duct and at least a second exhaust valve connected to the second exhaust duct separate and independent from the first exhaust duct;
the compressor means comprises a first turbocharger and the first exhaust duct is connected to the first turbocharger so that exhaust gases passing through the first exhaust duct drive the first turbocharger to rotate;
the second exhaust duct bypasses the first turbocharger and the combusted gases flowing through the second exhaust duct are exhausted without passing through the first turbocharger;
the electronic controller by controlling operation of the actuator means and thereby the opening and closing of the first and second exhaust valves is operable to control what proportion of the combusted gases leaving the combustion chamber flow through each of the first and second exhaust ducts;
the compressor means comprises additionally a supercharger;
the first turbocharger is a low pressure turbocharger which compresses intake air to a first pressure;
the supercharger is a high pressure supercharger which compresses the compressed air output by the first turbocharger to a second pressure higher than the first pressure;
the compressor means comprises additionally a bypass passage through which compressed air compressed by the first turbocharger can bypass the supercharger; and
bypass valve means is provided to control flow of compressed air through the bypass passage.

6. A turbocharged internal combustion engine as claimed in claim 5 wherein the bypass valve means is an electrically-controlled valve controlled by the electronic controller.

7. A turbocharged internal combustion engine comprising:
a variable volume combustion chamber;
inlet valve means controlling flow of air into the combustion chamber;
fuel delivery means for delivering fuel into the air to be mixed therewith;
exhaust valve means for controlling flow of combusted gases from the combustion chamber;
compressor means for compressing the air prior to admission of the air into the combustion chamber;
actuator means for opening and closing the exhaust valve means; and
an electronic controller which controls operation of the actuator means to thereby control opening and closing of the exhaust valve means, wherein;
the exhaust valve means comprises at least a first exhaust valve connected to a first exhaust duct and at least a second exhaust valve connected to a second exhaust duct separate and independent from the first exhaust duct;
the compressor means comprises a first turbocharger and the first exhaust duct is connected to the first turbocharger so that exhaust gases passing through the first exhaust duct drive the first turbocharger to rotate;
the second exhaust duct bypasses the first turbocharger and the combusted gases flowing through the second exhaust duct are exhausted without passing through the first turbocharger;
the electronic controller by controlling operation of the actuator means and thereby the opening and closing of the first and second exhaust valves is operable to control what proportion of the combusted gases leaving the combustion chamber flow through each of the first and second exhaust ducts;
the compressor means comprises additionally an electrically-driven compressor and the first turbocharger is a high pressure turbocharger which receives compressed air compressed by the electrically-driven compressor and pressurises the air to a higher level;
the compressor means comprises additionally a bypass passage through which air can bypass the electrically driven compressor to flow directly to the turbocharger;
an electrically-controlled bypass valve is provided to control flow of air through the bypass passage; and
the controller controls operation of the bypass valve and the electrically-driven compressor such that the electrically-driven compressor is operated only on starting the engine and/or at low engine speeds and otherwise intake air bypasses the electrically-driven compressor completely and is compressed only by the turbocharger.

8. A turbocharged internal combustion engine comprising:
a variable volume combustion chamber;
inlet valve means controlling flow of air into the combustion chamber;
fuel delivery means for delivering fuel into the air to be mixed therewith;
exhaust valve means for controlling flow of combusted gases from the combustion chamber;
compressor means for compressing the air prior to admission of the air into the combustion chamber;
actuator means for opening and closing the exhaust valve means; and
an electronic controller which controls operation of the actuator means to thereby control opening and closing of the exhaust valve means, wherein:
the exhaust valve means comprises at least a first exhaust valve connected to a first exhaust duct and at least a second exhaust valve connected to a second exhaust duct separate and independent from the first exhaust duct;
the compressor means comprises a first turbocharger and the first exhaust duct is connected to the first turbocharger so that exhaust gases passing through the first exhaust duct drive the first turbocharger to rotate;
the second exhaust duct bypasses the first turbocharger and the combusted gases flowing through the second exhaust duct are exhausted without passing through the first turbocharger;
the electronic controller by controlling operation of the actuator means and thereby the opening and closing of the first and second exhaust valves is operable to control what proportion of the combusted gases leaving the combustion chamber flow through each of the first and second exhaust ducts;
the compressor means comprises a second low pressure turbocharger which compresses air to a first pressure and the first turbocharger is a high pressure turbocharger which compresses air compressed by the low pressure turbocharger to a second pressure higher than the first pressure;
the first exhaust duct relays exhaust gas to the first high pressure turbocharger to drive the high pressure turbocharger to rotate and the second exhaust duct relays exhaust gas to the second lower pressure turbocharger, bypassing the first high pressure turbocharger, to drive the second low pressure turbocharger to rotate; and
the controller controls operation of the actuator means to control what proportion of combusted gases flowing from the combustion chamber flow through the first exhaust duct and what proportion flow through the second exhaust duct, the controller thereby controlling operation of the first high pressure and the second low pressure turbochargers.

9. A turbocharged internal combustion engine as claimed in claim 8 wherein the expanded exhaust gases leaving the first high pressure turbocharger are fed into the second exhaust duct to be relayed to the second low pressure turbocharger.

10. A turbocharged internal combustion engine as claimed in claim 8 wherein the compressor means comprises additionally a bypass passage through which air can bypass the first high pressure turbocharger and a bypass valve controlling flow of air through the bypass passage.

11. A turbocharged internal combustion engine as claimed in claim 10 wherein the bypass valve is controlled by the electronic controller.

12. A turbocharged internal combustion engine as claimed in claim 5 wherein the compressor means comprises additionally an intercooler for cooling the compressor intake air prior to delivery of the air into the combustion chamber.

13. A turbocharged internal combustion engine as claimed in claim 1 which comprises additionally a starting valve controlled by the electronic controller which can prevent flow of exhaust gases through the second exhaust duct during engine starting and wherein:
exhaust gases leaving the turbocharger supplied by the first exhaust duct are fed into the second exhaust duct upstream of the starting valve; and
the electronic controller during starting of the engine operates to close the starting valve and to open and close the exhaust valve means so that compressed gases leaving the combustion chamber are relayed via the first exhaust duct to the first turbocharger connected thereto to drive the said first turbocharger and then are returned to the combustion chamber via the second exhaust duct to be compressed again in the combustion chamber.

14. A turbocharged internal combustion engine as claimed in claim 1 comprising additionally a storage tank, a storage tank passage leading from the combustion chamber to the storage tank and cylinder head storage tank valve means controlling flow of combusted gases to the storage tank from the combustion chamber and also flow of stored combusted gases from the storage tank to the combustion chamber, whereby combusted gases compressed in the combustion chamber can be relayed to the storage tank for storage therein and for later return to the cylinder for expansion therein.

15. A turbocharged internal combustion engine as claimed in preceding claim 1 wherein the injector means can inject fuel into the combustion chamber early enough in an upstroke for mixing of the fuel with air to produce a homogeneous mixture which is then ignited by homogenous charge compression ignition and wherein the injection means can alternatively inject fuel later in the upstroke for compression ignition in the combustion chamber.

16. A turbocharged internal combustion engine as claimed in claim 15 wherein in part loading operating conditions of the engine the controller operates to close the exhaust valve means during the upstroke of the piston in order to trap combusted gases in the combustion chamber, the trapped combusted gases forming a mixture with the fuel and air and serving to delay ignition of the fuel and air mixture when the engine is operating with homogenous charge compression ignition.

17. A turbocharged internal combustion engine as claimed in claim 5 which comprises additionally a starting valve controlled by the electronic controller which can prevent flow of exhaust gases through the second exhaust duct during engine starting and wherein:
exhaust gases leaving the turbocharger supplied by the first exhaust duct are fed into the second exhaust duct upstream of the starting valve; and
the electronic controller during starting of the engine operates to close the starting valve and to open and close the exhaust valve means so that compressed gases leaving the combustion chamber are relayed via the first exhaust duct to the first turbocharger connected thereto to drive the said first turbocharger and then are returned to the combustion chamber via the second exhaust duct to be compressed again in the combustion chamber.

18. A turbocharged internal combustion engine as claimed in claim 5 comprising additionally a storage tank, a storage tank passage leading from the combustion chamber to the storage tank and cylinder head storage tank valve means controlling flow of combusted gases to the storage tank from the combustion chamber and also flow of stored combusted gases from the storage tank to the combustion chamber, whereby combusted gases compressed in the combustion chamber can be relayed to storage tank for storage therein and for later return to the cylinder for expansion therein.

19. A turbocharged internal combustion engine as claimed in claim 5 wherein the injector means can inject fuel into the combustion chamber early enough in an upstroke for mixing of the fuel with air to produce a homogenous mixture which is then ignited by homogenous charge compression ignition and wherein the injection means can alternatively inject fuel later in the upstroke for compression ignition in the combustion chamber.

20. A turbocharged internal combustion engine as claimed in claim 19 wherein in part load operating conditions of the engine the controller operates to close the exhaust valve means during the upstroke of the piston in order to trap combusted gases in the combustion chamber, the trapped combusted gases forming a mixture with the fuel and air and serving to delay ignition of the fuel and air mixture when the engine is operating with homogenous charge compression ignition.

21. A turbocharged internal combustion engine as claimed in claim 7, wherein the compressor means comprises additionally an intercooler for cooling the compressor intake air prior to delivery of the air into the combustion chamber.

22. A turbocharged internal combustion engine as claimed in claim 7, which comprises additionally a starting valve controlled by the electronic controller which can prevent flow of exhaust gases through the second exhaust duct during engine starting and wherein:
exhaust gases leaving the turbocharger supplied by the first exhaust duct are fed into the second exhaust duct upstream of the starting valve; and
the electronic controller during starting of the engine operates to close the starting valve and to open and close the exhaust valve means so that compressed gases leaving the combustion chamber are relayed via the first exhaust duct to the first turbocharger connected thereto to drive the said first turbocharger and then are returned to the combustion chamber via the second exhaust duct to be compressed again in the combustion chamber.

23. The turbocharged internal combustion engine as claimed in claim 7 comprising additionally a storage tank, a storage tank passage leading from the combustion chamber to the storage tank and cylinder head storage tank valve means controlling flow of combusted gases to the storage tank from the combustion chamber and also flow of stored combusted gases from the storage tank to the combustion chamber, whereby combusted gases compressed in the combustion chamber can be relayed to the storage tank for storage therein and for later return to the cylinder for expansion therein.

24. A turbocharged internal combustion engine as claimed in claim 27, wherein the injector means can inject fuel into the combustion chamber early enough in an upstroke for mixing of the fuel with air to produce a homogenous mixture which is then ignited by homogenous charge compression ignition and wherein the injection means can alternatively inject fuel later in the upstroke for compression ignition in the combustion chamber.

25. A turbocharged internal combustion engine as claimed in claim 24 wherein in part load operating conditions of the engine the controller operates to close the exhaust valve means during the upstroke of the piston in order to trap combusted gases in the combustion chamber, the trapped combusted gases forming a mixture with the fuel and air and serving to delay ignition of the fuel and air mixture when the engine is operating with homogenous charge compression ignition.

26. A turbocharged internal combustion engine as claimed in claim 8, wherein the compressor means comprises additionally an intercooler for cooling the compressor intake air prior to delivery of the air into the combustion chamber.

27. A turbocharged internal combustion engine as claimed in claim 8, which comprises additionally a starting valve controlled by the electronic controller which can prevent flow of exhaust gases through the second exhaust duct during engine starting and wherein:
exhaust gases leaving the turbocharger supplied by the first exhaust duct are fed into the second exhaust duct upstream of the starting valve; and
the electronic controller during starting of the engine operates to close the starting valve and to open and close the exhaust valve means so that compressed gases leaving the combustion chamber are relayed via the first exhaust duct to the first turbocharger connected thereto to drive the said first turbocharger and then are returned to the combustion chamber via the second exhaust duct to be compressed again in the combustion chamber.

28. A turbocharged internal combustion engine as claimed in claim 8 comprising additionally a storage tank, a storage tank passage leading from the combustion chamber to the storage tank and cylinder head storage tank valve means controlling flow of combusted gases to the storage tank from the combustion chamber and also flow of stored combusted gases from the storage tank to the combustion chamber, whereby combusted gases compressed in the combustion chamber can be relayed to the storage tank for storage therein and for later return to the cylinder for expansion therein.

29. A turbocharged internal combustion engine as claimed in claim 8 wherein the injector means can inject fuel into the combustion chamber early enough in an upstroke for mixing of the fuel with air to produce a homogenous mixture which is then ignited by homogenous charge compression ignition and wherein the injection means can alternatively inject fuel later in the upstroke for compression ignition in the combustion chamber.

30. A turbocharged internal combustion engine as claimed in claim 29 wherein in part load operating conditions of the engine the controller operates to close the exhaust valve means during the upstroke of the piston in order to trap combusted gases in the combustion chamber, the trapped combusted gases forming a mixture with the fuel and air and serving to delay ignition of the fuel and air mixture when the engine is operating with homogenous charge compression ignition.
